(19) United States
(12) Patent Application Publication
(10) Pub. No.: US 2026/0316713 A1
(43) Pub. Date: Oct. 15, 2026

(54) VEHICLE SEAT BELT STATUS CHANGE NOTIFICATION SYSTEM AND METHOD

(71) Applicant: Re:Car Inc., Troy, MI (US)

(72) Inventor: David Adam Edelstein, Seattle, WA (US)

(21) Appl. No.: 19/642,778

(22) Filed: Apr. 9, 2026

Related U.S. Application Data
(60) Provisional application No. 63/788,286, filed on Apr. 14, 2025.

(51) Int. Cl. B60R 22/48

(52) U.S. Cl. CPC B60R 22/48; B60R 2022/4866

(57) ABSTRACT

A system and method including detecting a buckle status of a first and second seat belt; detecting a change in the buckle status of at least one of the first and second seat belts; and in response to detecting the change in the buckle status, illuminating both the first indicator and the second indicator such that: the first indicator emits a first light when the first seat belt is engaged, a second light when the first seat belt is disengaged, and both the first light and the second light simultaneously when the first seat belt has not been previously engaged; and the second indicator emits a third light when the second seat belt is engaged, a fourth light when the second seat belt is disengaged, and both the third light and the fourth light simultaneously when the second seat belt has not been previously engaged.

### CROSS-REFERENCE TO RELATED APPLICATIONS

This application claims priority to U.S. 63/788,286 filed Apr. 14, 2025, the entirety of which is hereby incorporated by reference herein for all purposes.

### FIELD

The present disclosure relates generally to vehicle seat belt monitoring systems and methods and, more particularly, to systems and methods for detecting and providing a notification of a change in seat belt buckle status.

### BACKGROUND

A vehicle may include one or more indicators or telltales for visually communicating information to a driver. For example, a telltale may communicate information related to vehicle speed, battery level, tire pressure, traction control, whether one or more doors are open, turn signal activation, and other vehicle conditions. In many modern vehicles, such telltales are illuminated via light-emitting diodes (LEDs).

In some vehicles, telltales are configured to illuminate in multiple colors to communicate different vehicle conditions or information. For example, a telltale may be illuminated using a first LED of a first color and a second LED of a second color. To provide additional colors, additional LEDs and associated optical components are typically required, which may undesirably increase system cost, packaging constraints, and complexity.

Some vehicles include multiple rear seating positions, such as left, center, and right rear seats. If a rear seat belt becomes unbuckled during vehicle operation, it may be desirable to communicate this condition to the driver via a telltale. However, a notification that merely indicates that a rear seat belt is unbuckled may not identify which seating position corresponds to the unbuckled seat belt. As a result, the driver may need to visually inspect the rear seating area, which may distract the driver and reduce attention to the road.

Accordingly, there remains a need for improved systems and methods for communicating seat belt status information to a driver, including systems capable of identifying a particular seating position associated with a seat belt status change, without adding system cost and complexities.

### SUMMARY

Systems and methods are disclosed herein for communicating seat belt buckle status information to a driver. A vehicle may include one or more telltales or indicators associated with respective seat belts or buckles, such as rear seat belts corresponding to different seating positions. The indicators may be selectively illuminated based on detected seat belt buckle statuses such that a driver can visually determine whether a particular seat belt is engaged, disengaged after previously being engaged, or has not been previously engaged. Advantageously, the telltales may be illuminated to provide a visual representation or map of the rear seat and corresponding buckle statuses, enabling a driver to readily identify which seat belt has been unbuckled and/or buckled during vehicle operation.

A vehicle may include a first indicator associated with a first seat belt and a second indicator associated with a second seat belt. A buckle status for each of the first and second seat belts may be detected, and a change in the buckle status of at least one of the seat belts may be identified. In response to detecting the change, both indicators may be illuminated in accordance with the respective buckle statuses of the seat belts.

For example, the first indicator may emit a first light or color when the first seat belt is engaged, emit a second light or color when the first seat belt becomes disengaged after previously being engaged, and emit both the first and second lights simultaneously, or a third color, when the first seat belt has not been previously engaged. Similarly, the second indicator may emit a first light or color when the second seat belt is engaged, emit a second light or color when the second seat belt becomes disengaged after previously being engaged, and emit both lights simultaneously, or a third color, when the second seat belt has not been previously engaged.

A controller, processor, computer, or the like may be configured to detect a buckle status and/or a change in the buckle status for one or more seat belts. The controller may be configured to obtain signals from one or more buckle sensors or devices indicative of a buckle status and/or a change in buckle status.

In some implementations, a change in buckle status may be detected when a seat belt becomes disengaged during vehicle operation. In other implementations, the change in buckle status may be detected when a seat belt becomes engaged before or during vehicle operation.

In certain embodiments, the first light and the third light may be green lights and the second light and the fourth light may be red lights. In some implementations, simultaneous emission of two lights may produce a third visual state or color, such as yellow.

In certain embodiments, a vehicle may include a third seat belt and a corresponding third indicator associated with a third seating position. The third indicator may emit a first light or color when the third seat belt is engaged, emit a second light or color when the third seat belt becomes disengaged after previously being engaged, and emit a third color when the third seat belt has not been previously engaged. The first color may be generated by a first light or bulb, the second color may be generated by a second light or bulb, and the third color may be generated by illuminating the first and second lights or bulbs simultaneously which results in a third color.

In some implementations, a change in the buckle status of one of the seat belts may cause all telltales or indicators associated with multiple seating positions to be illuminated so that the driver may simultaneously view the buckle status of multiple seat belts.

The vehicle disclosed herein may include, for example, an automobile, sport utility vehicle (SUV), truck, van, or bus. In addition, the vehicle may include other types of transportation platforms, such as watercraft (e.g., boats or ships), aircraft (e.g., airplanes or helicopters), rail vehicles (e.g., trains or trams), and off-road or recreational vehicles (e.g., all-terrain vehicles (ATVs), utility task vehicles (UTVs), or snowmobiles)

The vehicle may be one that is reconfigurable between two or more configurations. For example, the vehicle may be reconfigurable between a pickup truck configuration and a sport utility (SUV) configuration. The vehicle may comprise a frame comprising a front region that is located generally over a pair of front wheels of the vehicle and a rear region that is located generally over a pair of rear wheels of the vehicle. The vehicle may have a rear region having a pair of opposing bed walls and a rear floor. The frame may have one or more frame fastening devices; and a rear enclosure assembly configured to attach to the one or more frame fastening devices on the frame to reconfigure the vehicle from the pickup truck configuration to the SUV configuration. The rear enclosure assembly may include a roll bar assembly comprising a structure having a pair of spaced apart pillars, an upper cross bar connected to upper regions of the pillars, and optionally a lower cross bar connected to lower regions of the pillars. One or more rear passenger seats may be configured for attachment to the frame and/or roll bar assembly. The one or more rear passenger seats comprise the first seat belt, the second seat belt, and/or the third seat belt and corresponding buckle detector. A vehicle controller or processor may be configured to monitor a buckle status of the seat belts and/or buckles according to the teachings herein and to display the buckle status to a driver or one or more vehicle operators or passengers according to the system and method disclosed herein.

The teachings provide a system and method for visually alerting a driver of a vehicle that has been reconfigured from a pickup truck configuration to a sport utility (SUV) configuration about a buckle status of a seat belt in the vehicle. The system may comprise: a roll bar assembly comprising a hoop structure having a pair of spaced apart pillars, an upper cross bar connected to upper regions of the pillars, and optionally a lower cross bar connected to lower regions of the pillars or to the vehicle frame; one or more rear passenger seats configured for attachment to the roll bar assembly; a first indicator associated with a first seat belt of the one or more rear passenger seats in the vehicle and configured to be illuminated by a first light and a second light; a second indicator associated with a second seat belt of the one or more rear passenger seats in the vehicle and configured to be illuminated by a third light and a fourth light; wherein after the first seat belt is engaged, then the first indicator is illuminated by the first light; and if during vehicle operation the first seat belt is disengaged, then: the first indicator is illuminated by the second light, and the second indicator is illuminated by both of the third light and the fourth light if the second seat belt was not engaged; or wherein after the second seat belt is engaged, then the second indicator is illuminated by the third light; and during vehicle operation if the first seat belt is disengaged, then: the first indicator is illuminated by the second light, and the second indicator is illuminated by the third light; OR wherein during vehicle operation if the first seat belt is disengaged and the second seat belt is engaged and then disengaged, then: the first indicator is illuminated by the second light, and the second indicator is illuminated by the fourth light; OR wherein if the second seat belt is engaged and then disengaged, then: the first indicator is illuminated by the first light if the first seat belt remains engaged, and the second indicator is illuminated by the fourth light.

### BRIEF DESCRIPTION OF THE DRAWINGS

FIG. 1 is a perspective view of a vehicle in a pickup truck configuration.

FIG. 2 is a perspective view of a vehicle in a sport utility vehicle (SUV) configuration.

FIG. 3 is a perspective view of a vehicle in a sport utility vehicle (SUV) configuration.

FIG. 4 is a perspective view of a rear passenger seat.

FIG. 5 is a front view of a vehicle information device having plurality of indicators or telltales.

FIG. 6 is a schematic illustration of the system disclosed herein.

### DETAILED DESCRIPTION

The present description relates generally to a method and system of informing or notifying a driver or one or more vehicle occupants of a change in status of a seat belt buckle in a vehicle. Though applicable to numerous vehicle types, the system and method is particularly well suited for use with a vehicle employing an electrical propulsion system (e.g., a battery powered vehicle having no internal combustion engine). Among the vehicles to which the subject of the description may be employed is a vehicle that is reversibly configurable between a pickup truck configuration and a sport utility vehicle configuration.

For example, the system and method according to this description is adapted for use with the reconfigurable vehicle illustrated and described in U.S. 63/785,542 filed on Apr. 8, 2025, U.S. 63/788,545 filed on Apr. 14, 2025, and/or U.S. 63/792,518 filed on Apr. 22, 2025, the entireties of which are all hereby incorporated by reference herein for all purposes.

Further aspects of the vehicle 10, the one or more configurations or states 13,15, the rear enclosure assembly 61, and elements thereof are disclosed in U.S. patent application Ser. No. 19/642,294 filed on Apr. 8, 2026, the entirety of which is incorporated herein by reference.

By way of summary, the vehicle for which this system and method may be adapted for can be reconfigured from a first vehicle configuration to a second vehicle configuration. The vehicle can be reconfigured back to the first vehicle configuration. In other words, the vehicle has a reversible configurable structure. In the context of the present description, “reversibly configurable” refers to structure having ability to be reconfigured (e.g., converted or transformed) from a first configuration to a second configuration and back to the first configuration. In this regard, “reversibly configurable” includes an ability of a structure to be reconfigured without permanently altering the structure in a way that would inhibit the structure from being reconfigured back to a previous configuration. For example, the structure may be reversibly configured from and/or between the first vehicle configuration to a second vehicle configuration without using permanent fasteners like adhesives or welding. For example, the structure may be reversibly configured from and/or between a first vehicle configuration to a second vehicle configuration without the need for using destructive material removal techniques causing permanent deformation such as cutting, milling, grinding, etc.

One of the vehicle configurations (e.g., first vehicle configuration or second vehicle configuration) may be a pickup truck or pickup truck configuration. The other vehicle configuration (e.g., first vehicle configuration or second vehicle configuration) may be a sport utility vehicle (SUV) or SUV configuration.

A “pickup truck” includes a vehicle that may be a light, medium-duty or heavy-duty truck. The pickup truck configuration may include a vehicle having an enclosed cab or cockpit (for at least a driver and at least one occupant) and an open cargo area, namely a bed, located in the rear portion of the vehicle and being operable for storing and/or transporting cargo. A pickup truck configuration may be a vehicle that does not include a C-pillar, e.g., does not include a C-pillar that defines part of a passenger cab. A pickup truck configuration may be a vehicle that does not include a D-pillar. A pickup truck configuration may be a vehicle that has a removable bulkhead panel and rear window or glass assembly that can be completely removed or separated from the vehicle.

A “sport utility vehicle” includes a vehicle that may be a light, medium-duty or heavy-duty vehicle including an enclosed cab (for at least a driver and at least one and preferably a plurality of occupants), a cargo area enclosed by an enclosure, and a space behind a driver seat for or providing additional passenger seating. Thus, a “sport utility vehicle” includes a vehicle that is configured to receive at least one rear seat, at least one seat belt, and optionally at least one air bag (e.g., a side curtain airbag mounted in an upper part of the vehicle adjoining an edge portion of the vehicle roof, side panel or door airbag, etc.). When the vehicle is converted into the SUV configuration, C- and D-pillars may be added.

The vehicle may include a chassis comprising one or more batteries to supply power to one or more motors to propel the vehicle; a frame supported on, by, or with the chassis and comprising a front region that is located generally over a pair of front wheels of the vehicle and a rear region that is located generally over a pair of rear wheels of the vehicle, rear region having a pair of opposing bed walls and a rear floor, wherein frame comprises one or more preexisting frame fastening devices; a rear enclosure assembly configured to attach to the one or more preexisting fasteners on the frame to reconfigure the vehicle from the pickup truck configuration to the SUV configuration, the rear enclosure assembly comprising: a roll bar assembly comprising a hoop structure having a pair of spaced apart pillars, an upper cross bar connected to upper regions of the pillars, and an optional lower cross bar; and one or more rear passenger seats configured for attachment to the roll bar assembly and/or vehicle frame.

As used herein, “preexisting” refers to fastening features incorporated into or on the vehicle frame by the original vehicle manufacturer during original manufacture and prior to the vehicle being placed into service. For example, the plurality of preexisting frame fastening devices comprise threaded fasteners, weld nuts, threaded bores, or combinations thereof installed prior to reconfiguration of the vehicle. The rear enclosure assembly is attachable to the vehicle frame without welding, bonding, cutting, drilling, or grinding the vehicle frame. The rear enclosure assembly is removable from the vehicle frame to return the vehicle to the pickup truck configuration using the plurality of preexisting frame fastening devices.

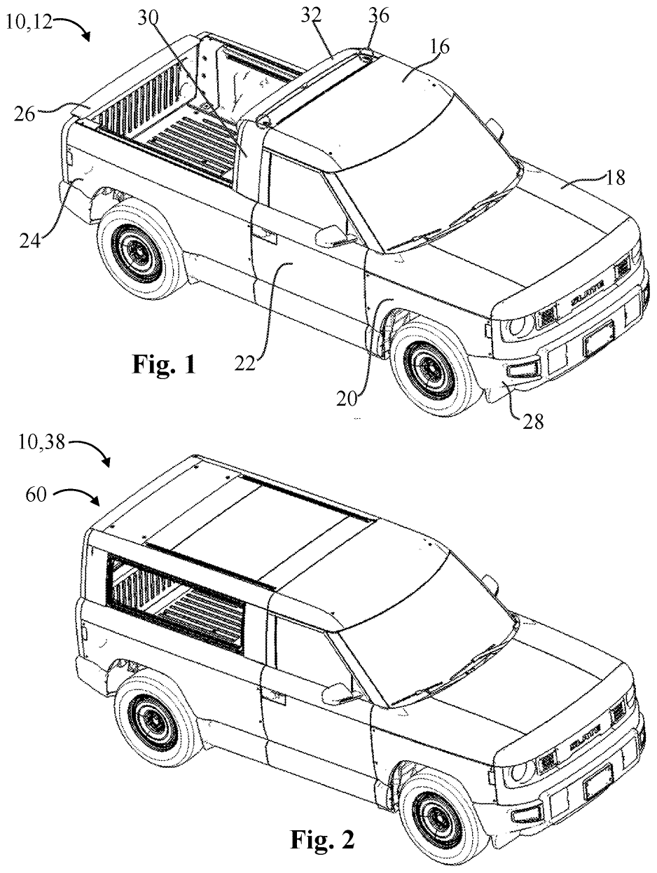

FIG. 1 illustrates an exemplary vehicle 10 in a pickup truck configuration 12. The vehicle 10 comprises a frame. One or a plurality of vehicle body panels may be attached or supported on or by the frame. An exemplary list of vehicle body panels may include one or more roof panels 16, a front hood panel 18, a pair of front fenders 20, a pair of door panels 22, a pair of rear fenders 24, a tailgate 26, front and rear bumper covers 28, B-pillar panels or appliques 30, a vehicle cab spoiler 32.

FIG. 2 illustrates a vehicle 10 in the SUV configuration 38. The vehicle 10 has been converted or transformed from the pickup truck configuration to the SUV configuration 38. Briefly stated, a rear enclosure assembly 60 has been attached to the vehicle 10 and frame to convert the vehicle into the SUV configuration. In the SUV configuration, one or more rear seats have been added to the vehicle.

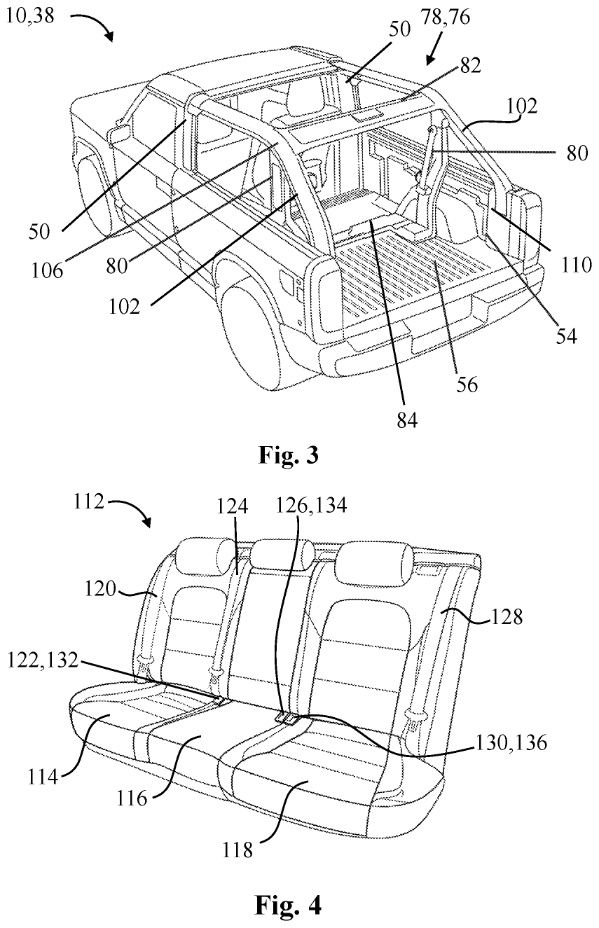

FIG. 3 illustrates a vehicle 10 in the SUV configuration 38. The vehicle 10 has been converted or transformed from the pickup truck configuration to the SUV configuration 38. One or more of the rear enclosure panels have been removed so the vehicle has an open-air or safari configuration. This also allows the roll bar assembly 78 and hoop structure 76 to be shown and described.

The hoop structure 76 comprises a pair of spaced apart pillars 80, an upper cross bar 82 extending between and connected to upper regions of the pillars 80, and optionally a lower cross bar 84 connected to lower regions of the pillars 80 and/or vehicle frame and/or floor 56 of the vehicle. The roll bar assembly may have a pair of longitudinal rails 102 that connect to or extend from the B-pillars 50 of the vehicle to a pocket or slot 110 in the rear of the vehicle frame of the bed walls 54. One or more rear passenger seats are configured for attachment to hoop structure 76, roll bar assembly 78, pillars 80, lower cross bar 84, vehicle frame, rear floor 56 of the vehicle, one or more bed walls 54, or a combination thereof.

FIG. 4 illustrates a rear passenger seat 112. In various configurations, the rear passenger seat may be a bench seat, two or more captain's chairs, a 40/40 or 60/40 split seat, or any combination thereof. Other seat configurations are also envisioned.

The rear passenger seat 112 may comprise one or more seating areas. For example, in FIG. 4, the rear passenger seat 112 comprises a first seating area 114, a second seating area 116, and a third seating area 118. In some configurations, the rear seat 112 may only have two seating areas (e.g., first and second seating areas 114, 116). In other configurations, there may be more than three seating areas.

In some configurations, the vehicle may include one or more additional rows of passenger seats positioned behind the passenger seat 112 (e.g., third-row seating, fourth-row seating, or other multi-row configurations). For example, a third row of seating having one or more passenger seats 112 may be arranged behind a second row of passenger seats. The systems and methods described herein may be applied to such multi-row seating configurations.

Each of the one or more seating areas may comprise a passenger restraint system. A passenger restraint system may comprise a seat belt and a buckle. The seat belt may be a shoulder belt, a lap belt, or both. In three seating area passenger seat configurations, the first seating area 114 may comprise a first seat belt 120 and a first seat belt buckle 122, the second seating area 116 may comprise a second seat belt 124 and a second seat belt buckle 126, and the third seating area 118 may comprise a third seat belt 128 and a third seat belt buckle 130.

Each of the seat belt buckles 122, 126, 130 may comprise a respective seat belt buckle detector 132, 134, 136. A seat belt buckle detector may comprise any device, sensor, or combination of components configured to detect a state of engagement between a seat belt and a corresponding seat belt buckle. The detector may be configured to determine when the seat belt is latched (engaged) and unlatched (disengaged). The seat belt buckle detector may include, for example, a mechanical switch, microswitch, magnetic sensor (e.g., Hall-effect sensor), optical sensor, capacitive sensor, resistive contact sensor, or any other suitable sensing mechanism. The detector may be positioned within the buckle housing, coupled to a latch mechanism, or otherwise arranged to detect movement, position, or presence of the seat belt tongue relative to the buckle. In some embodiments, the seat belt buckle detector may generate a signal indicative of the engagement state, such as a binary signal (latched/unlatched) or a multi-state signal. The signal may be transmitted to a vehicle control system, electronic control unit (ECU), or other processing device for use in the system and method disclosed herein.

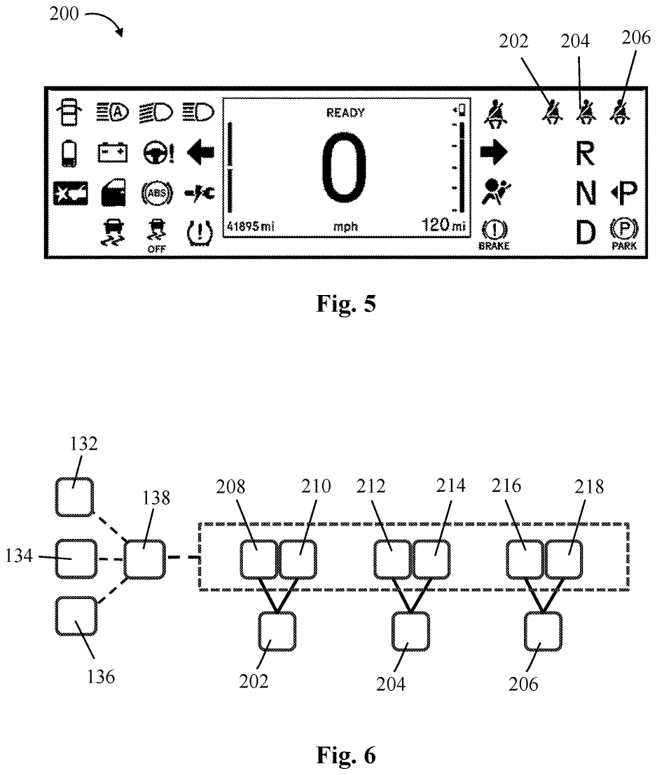

FIG. 5 illustrates a vehicle information device 200 having one or more indicators or telltales. The one or more indicators may provide a visual indicator or alert to a driver of the vehicle. For example, the one or more indicators may provide information about the vehicle, such as vehicle speed, battery level, parking brake engagement, low tire pressure, turn signals, high beam lights. One or more of the indicators may include information about a buckle status of a seat belt in the vehicle.

The vehicle information device 200 may be located in a dashboard, instrument panel, console, or windshield of the vehicle (e.g., heads up display). The vehicle information device 200 may be an app or program that runs on a mobile device such as a table or phone that is connected to the vehicle.

The one or more indicators may include a first indicator 202 associated with a first seating area of the rear passenger seat, a second indicator 204 associated with a second seating area of the rear passenger seat, a third indicator 206 associated with a third seating area of the rear passenger seat, etc.

FIG. 6 illustrates a schematic of the system according to these teachings.

The first indicator 202 is configured to be illuminated by a first light 208 and a second light 210. The second indicator 204 is configured to be illuminated by a third light 212 and a fourth light 214. The third indicator 206 is configured to be illuminated by a fifth light 216 and a sixth light 218. One or more of the lights may be a light emitting diode (LED). Each of the pair of lights associated with an indicator may be configured to generate light through a light guide or light tube to illuminate the respective indicator from behind. For example, the first and second lights 208, 210 may be configured to illuminate light through a single light tube or guide to illuminate the indicator 202.

The pair of lights associated with an indicator may be different colors. For example, the first light 208 may be a green light and the second light 210 may be a red light. The same may be true for the other pair of lights for each respective indicator 204, 206. In other words, the third light 212 and the fifth light 216 may be green lights, and the fourth and sixth lights 214, 2018 may be red lights.

Preferably, the light pairs (e.g., first and second lights, third and fourth lights, and fifth and sixth lights) are colors such that when combined or both illuminated they generate a third color. For example, the first light may be green, the second light may be red, and when they are both simultaneously illuminated, a yellow light is generated.

The system and method according to the teachings herein may be configured to illuminate all seat belt indicators or telltales when there is a change in buckle status of any seat belt in the rear of the vehicle.

For example, if only one seat belt is buckled, all indicators may be illuminated upon buckling of the seat belt. If, during vehicle operation, any one of the seat belts becomes unbuckled, all indicators may again be illuminated, regardless of whether other seat belts remain buckled. Advantageously, the indicators provide the driver with a map or a representation of the rear seating positions, such that the driver is immediately informed of a change in seat belt status during vehicle operation without needing to turn their head or divert attention from the road, while still enabling identification of which seat belt has been bucked or unbuckled.

Advantageously, the system and method according to these teachings works with one or more rear seats that do not have an occupancy, presence, or weight sensor.

The vehicle or system may comprise a controller, processor, or computer 138 configured to selectively activate or illuminate one or more lights 208, 210, 212, 214, 216, 218 or indicators 202, 204, 206 based on one or more signals received from the one or more seat belt buckle detectors 132, 134, 136.

The system, controller, processor, or computer 138 may be configured to receive one or more signals from the one or more seat belt buckle detectors 132, 134, 136 indicative of engagement and/or disengagement of one or more seat belts (e.g., seat belt latch engaging the seat belt buckle). The controller 138 may process such signals to determine the status of seat belt and control the corresponding indicators accordingly. The controller 138 may process such signals to previously received signals to determine the status of seat belt and control the corresponding indicators accordingly. The system and/or method may obtain, transmit, or communicate these signals from the one or more detectors to the one or mor processors and to the one or more lights via one or more wired connections (e.g., a wire harness) and/or via one or more wireless communication protocols, such as Bluetooth®, cellular communication, or other suitable short-range or long-range communication technologies. In some embodiments, the signals may be transmitted in real time or near real time to enable timely updates of the indicators.

As used herein, “vehicle operation” may refer to any state in which the vehicle is powered and/or capable of movement. For example, vehicle operation may include when the vehicle is turned ON, when an ignition system or propulsion system is activated, when the vehicle is placed into a drive mode or gear (e.g., drive, reverse, neutral, or park), or when the vehicle is otherwise enabled for motion. In some embodiments, vehicle operation may further include periods in which the vehicle is stationary but powered, such as when idling, stopped in traffic, or temporarily halted with the propulsion system active. In other embodiments, vehicle operation may include hybrid or electric vehicle states in which a motor or engine is selectively active or inactive while the vehicle remains enabled for movement. Accordingly, “vehicle operation” may encompass a range of operating conditions in which monitoring of seat belt status and/or activation of one or more indicators is desired.

During vehicle operation, if a seat belt is not buckled, the controller or processor may cause one or more lights associated with the corresponding indicator may be illuminated to indicate an unbuckled state. In some embodiments, the controller or processor may cause multiple lights of a light pair may be illuminated simultaneously. For example, both lights associated with a given indicator (e.g., first and second lights, third and fourth lights, and fifth and sixth lights) may be illuminated at the same time. In some embodiments, simultaneous illumination of the multiple lights may produce a combined or third color. For example, illumination of a first light of a first color and a second light of a second color may result in a third color (e.g., yellow resulting from simultaneous illumination of red and green lights).

If a seat belt remains in a buckled state, the controller or processor may cause one or more lights of the corresponding indicator may be illuminated to indicate the buckled condition. For example, if a seat belt remains buckled, a first light of the corresponding light pair may be illuminated (e.g., a green light).

If a seat belt that was previously buckled becomes unbuckled, the controller or processor may cause one or more lights of the corresponding indicator may be illuminated to indicate a transition from a buckled state to an unbuckled state. For example, if a previously buckled seat belt is subsequently detected as unbuckled, a second light of the corresponding indicator may be illuminated (e.g., a red light).

Table 1 below summarizes the indicator illumination states for indicators corresponding to multiple seat belts. Each indicator is configured or controlled by the controller or processor to emit a first light when the corresponding seat belt is engaged, a second light when the seat belt becomes disengaged after having been engaged, and both lights when the seat belt has not been previously engaged.

TABLE 1

| | | Indicator State When | Indicator State When |
|---|---|---|---|
| | Indicator State When Seat Belt | Seat Belt Becomes | Seat Belt Has Not Been |
| Seat Belt # | is Engaged | Disengaged | Previously Engaged |
| 1 | First Light | Second Light | First and Second Lights |
| 2 | Third Light | Fourth Light | Third and Fourth Lights |
| 3 | Fifth Light | Sixth Light | Fifth and Sixth Lights |

Upon a change in status of any one of the seat belts, all indicators 202, 204, 206 may be illuminated to display respective seat belt statuses. This may provide a visual representation of rear seating positions such that a driver can identify a seat belt status without diverting attention from the road.

The system and method may be configured to illuminate one or more indicators 202, 204, 206 for a predetermined period of time before the illumination is deactivated. In some embodiments, the indicators 202, 204, 206 may be illuminated in response to engagement and/or disengagement of a seat belt and maintained in an illuminated state for a defined duration. For example, the indicators may be illuminated for about 3 seconds or more, 5 seconds or more, 7 seconds or more, 10 seconds or more, or within any suitable time range.

In this manner, the duration of illumination may be selected to provide sufficient time to notify the driver of a seat belt status condition while reducing prolonged illumination that could contribute to distraction or unnecessary power consumption.

In some configurations, the vehicle may have only two seat belts. In such a configuration, the system and method only utilize two indicators 202, 204.

Table 2 below illustrates example illumination states for indicators 202, 204, 206 corresponding to multiple seat belts in a vehicle. As shown, the vehicle includes a first indicator associated with a first seat belt, a second indicator associated with a second seat belt, and a third indicator associated with a third seat belt. Each indicator is configured to emit one or more lights that correspond to a buckle status of the associated seat belt.

TABLE 2

| Seat Belt Status | Indicator for | Indicator for | Indicator for |
|---|---|---|---|
| Condition | Seat 1 | Seat 2 | Seat 3 |
| All seat belts engaged | First Light | Third Light | Fifth Light |
| Seat 1 disengaged, | Second Light | Third Light | Fifth Light |
| Seat 2 engaged, | | | |
| Seat 3 engaged | | | |
| Seat 2 disengaged, | First Light | Fourth Light | Fifth Light |
| Seat 1 engaged, | | | |
| Seat 3 engaged | | | |
| Seat 3 disengaged, | First Light | Third Light | Sixth Light |
| Seat 1 engaged, | | | |
| Seat 2 engaged | | | |
| Seat 1 never engaged, | First and Second | Third Light | Fifth Light |
| Seat 2 engaged, | Lights | | |
| Seat 3 engaged | | | |
| Seat 2 never engaged, | First Light | Third and Fourth | Fifth Light |
| Seat 1 engaged, | | Lights | |
| Seat 3 engaged | | | |
| Seat 3 never engaged, | First Light | Third Light | Fifth and Sixth |
| Seat 1 engaged, | | | Lights |
| Seat 2 engaged | | | |
| Seat 1 disengaged, | Second Light | Fourth Light | Fifth Light |
| Seat 2 disengaged, | | | |
| Seat 3 engaged | | | |
| Seat 1 disengaged, | Second Light | Third Light | Fifth and Sixth |
| Seat 2 engaged, | | | Lights |
| Seat 3 never engaged | | | |

In table 2 above, each seat belt may have three possible states: engaged, disengaged after previously being engaged, and never engaged. The indicators are illuminated according to these states such that a driver can readily determine the status of each seat belt.

More specifically, when a seat belt is engaged, the corresponding indicator is illuminated using a first light associated with that seat. When the seat belt becomes disengaged after having been previously engaged, the corresponding indicator is illuminated using a second light associated with that seat. When the seat belt has not been previously engaged, the corresponding indicator is illuminated using both lights associated with that seat.

For example, the first indicator may emit a first light when the first seat belt is engaged, a second light when the first seat belt becomes disengaged, and both the first light and the second light when the first seat belt has not been previously engaged. Similarly, the second indicator may emit a third light, a fourth light, or both the third and fourth lights depending on the status of the second seat belt, and the third indicator may emit a fifth light, a sixth light, or both the fifth and sixth lights depending on the status of the third seat belt.

The first light may be a first color (e.g., green) and the second light may be a second color (e.g., red). Other light or bulb colors may be used. In some embodiments, the colors may be selected such that simultaneous illumination of the first and second lights produces a combined or third color. In this manner, a third color may be generated without requiring a separate light source, which may reduce system cost and complexity.

As further illustrated in Table 2, when a change in buckle status of any seat belt is detected, the system updates illumination of all indicators so that the driver can simultaneously view the buckle status of each seat belt. For example, if the first seat belt becomes disengaged while the second and third seat belts remain engaged, the first indicator may emit the second light while the second and third indicators continue to emit the third and fifth lights, respectively. In another example, if the second seat belt becomes disengaged while the first and third seat belts remain engaged, the second indicator may emit the fourth light while the first and third indicators emit the first and fifth lights, respectively. Additional combinations of seat belt states and corresponding indicator illumination are also illustrated in Table 2.

The examples shown in Table 2 are illustrative and not limiting. Other combinations of seat belt states may occur, and the indicators may be illuminated according to the same principles described above.

Structures, steps, and/or functional features of one embodiment may be substituted for corresponding structures, steps, and/or functional features of another embodiment, unless the description herein indicates that they are mutually exclusive alternatives and/or such substitution would require a substantial modification of the non-substituted subject matter.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference in each of their entirety for all purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps. The term “consists essentially of” means excluding other elements that contribute in a material way to the recited function, unless otherwise defined herein; nonetheless, such other elements may be present, collectively or individually, provided that, in their absence, the recited function would otherwise be achieved.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

Unless otherwise explicitly stated herein, reference to attachment and/or connection of two or more structures to one another contemplates both a direct and indirect connection; it being understood further that, unless otherwise explicitly stated herein, a “direct connection” or “direct attachment” also includes within its scope the inclusion of a thin element (e.g., an element with a maximum thickness at a location in contact with both joined structures of less than 10 millimeters, preferably less than 7 millimeters, and more preferably less than 3 millimeters) between the joined structures. Thus, unless explicitly stated, a direct connection between two elements may include the elements and an intermediate element, such as a seal, a washer, an adhesive layer, a primer layer, or the like.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

1. A method for providing a visual notification of a seat belt buckle status in a vehicle with a first indicator associated with a first seat belt of the vehicle and a second indicator associated with a second seat belt of the vehicle, the vehicle being reconfigurable between a pickup truck configuration and a sport utility vehicle (SUV) configuration, the vehicle comprising a vehicle frame configured to support both the pickup truck configuration and the SUV configuration and to allow reconfiguration therebetween without permanently modifying the vehicle frame, the method comprising:
detecting a buckle status of the first seat belt and the second seat belt;
detecting a change in the buckle status of at least one of the first seat belt and the second seat belt; and
in response to the detecting the change in the buckle status of at least one of the first seat belt and the second seat belt, causing both the first indicator and the second indicator to illuminate such that:
i. the first indicator emits a first light when the first seat belt is engaged, emits a second light when the first seat belt becomes disengaged after previously being engaged, and emits both the first light and the second light simultaneously when the first seat belt has not been previously engaged; and
ii. the second indicator emits a third light when the second seat belt is engaged, emits a fourth light when the second seat belt becomes disengaged after previously being engaged, and emits both the third light and the fourth light simultaneously when the second seat belt has not been previously engaged.

2. The method according to claim 1, wherein the detecting the change in the buckle status comprises detecting that the first seat belt and/or the second seat belt becomes disengaged during vehicle operation.

3. The method according to claim 1, wherein the detecting the change in the buckle status comprises detecting that the first seat belt and/or the second seat belt becomes engaged before or during vehicle operation.

4. The method according to claim 1, wherein the first light and the third light are green lights.

5. The method according to claim 1, wherein the second light and the fourth light are red lights.

6. The method according to claim 1, wherein simultaneous emission of the first light and the second light produces a yellow light.

7. The method according to claim 1, further comprising a third seat belt and a third indicator associated with the third seat belt.

8. The method according to claim 7, wherein in response to the detecting the change in the buckle status of at least one of the first seat belt and the second seat belt, causing the third indicator to illuminate such that: the third indicator emits a fifth light when the third seat belt is engaged, emits a sixth light when the third seat belt becomes disengaged after previously being engaged, and emits both the fifth light and the sixth light simultaneously when the third seat belt has not been previously engaged.

9. A method for providing a visual notification of a change in a seat belt buckle status with a first indicator associated with a first seat belt, a second indicator associated with a second seat belt, and a third indicator associated with a third seat belt, the method comprising:
detecting a buckle status of the first seat belt, the second seat belt, and the third seat belt;
detecting a change in buckle status of at least one of the first seat belt, the second seat belt, and the third seat belt; and
in response to the detecting the change in buckle status of the first seat belt, the second seat belt, and the third seat belt, simultaneously causing the first indicator, the second indicator, and the third indicator to illuminate.

10. The method according to claim 9, wherein each indicator is configured to emit a first color when the corresponding seat belt is engaged, emit a second color when the seat belt becomes disengaged after having been previously engaged, and emits a third color when the seat belt has not been previously engaged.

11. The method according to claim 10, wherein the first color is generated by illuminating a first LED, the second color is generated by illuminating a second LED, and the third color is generated by illuminating the first LED and the second LED.

12. A seat belt status notification system comprising: a controller configured to detect the buckle status of the first seat belt buckle and the second seat belt buckle and to illuminate the first indicator and the second indicator according to the method of claim 1.

13. The system according to claim 12, wherein the first seat belt comprises a first seat belt buckle detector and the second seat belt comprises a second seat belt buckle detector;

14. The system according to claim 13, further comprising a third seat belt, a third indicator associated with the third seat belt, a third seat belt buckle detector.

15. The system according to claim 14, wherein in response to the detecting the change in the buckle status of at least one of the first seat belt and the second seat belt, the controller is configured to cause the third indicator to illuminate such that: the third indicator emits a fifth light when the third seat belt is engaged, emits a sixth light when the third seat belt becomes disengaged after previously being engaged, and emits both the fifth light and the sixth light simultaneously when the third seat belt has not been previously engaged.

16. The system according to claim 15, wherein the lights are emitted by light-emitting diodes (LEDs), and wherein the first light, the second light, the third light, the fourth light, the fifth light, and the sixth light are optically coupled to the respective indicators through one or more light pipes.
